(19) United States
(12) Patent Application Publication
(10) Pub. No.: US 2011/0001824 A1
(43) Pub. Date: Jan. 6, 2011

(54) SENSING APPARATUS, EVENT SENSING METHOD, AND PHOTOGRAPHING SYSTEM

(75) Inventor: Il-kwon CHANG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Techwin Co., Ltd., Changwon-city (KR)

(21) Appl. No.: 12/775,832

(22) Filed: May 7, 2010

(30) Foreign Application Priority Data
Jul. 3, 2009 (KR) 10-2009-60615

(51) Int. Cl. H04N 7/18

(52) U.S. Cl. 348/143; 348/E07.085

(57) ABSTRACT

A sensing apparatus determines a location and a direction where a display and an event are sensed, and causes a separate event to occur based on the location and the direction where the event is sensed. Accordingly, a user may set a direction where the event is sensed on a photographed screen more easily and conveniently.

### CROSS-REFERENCE TO RELATED APPLICATIONS

This application claims priority under 35 U.S.C. §119 from Korean Patent Application No.10-2009-60615, filed on Jul. 3, 2009, in the Korean Intellectual Property Office, the disclosure of which is incorporated herein by reference in its entirety.

### BACKGROUND

1. Field of the Invention

Apparatuses and methods consistent with the present general inventive concept relate to a sensing apparatus, an event sensing method and a photographing system, and more particularly, to a sensing apparatus to sense an event on a photographed screen, and an event sensing method and a photographing system thereof.

2. Description of the Related Art

A video cassette recorder (VCR) used for a surveillance camera has low image quality and has a lot of inconveniences including having to replace a tape frequently. In order to reduce such inconveniences, a digital video recorder (DVR) using a hard disk drive (HDD) or a digital video disk (DVD) has been developed, and with the rapid development of such a digital storage medium, it becomes possible to operate a surveillance camera for a long time. As it is possible to operate a surveillance camera for an extended period of time, the surveillance camera has been more widely used.

A recent photographing apparatus or a photographing system is capable of not only photographing an image, but also photographing an image taking into consideration a direction or movement of a subject to be photographed. For example, the photographing apparatus or the photographing system may turn on the light if it detects a person crossing the street, or may control photographing operation in other ways according to a detected direction or movement of a subject to be photographed.

However, in order to consider the direction or movement of a subject when a control command is generated, a user should match each of the control command with the direction of the subject via a menu screen, and this causes great inconvenience to a user.

### SUMMARY

Exemplary embodiments of the present general inventive concept address at least the above problems and/or disadvantages and other disadvantages not described above. Also, the present general inventive concept is not required to overcome the disadvantages described above, and an exemplary embodiment of the present general inventive concept may not overcome any of the problems described above.

The present general inventive concept relates to a sensing apparatus to make it easier to set a direction for sensing an event on a photographed screen, and an event sensing method and a photographing system thereof.

Additional aspects and utilities of the present general inventive concept will be set forth in part in the description which follows and, in part, will be obvious from the description, or may be learned by practice of the general inventive concept.

Features and/or utilities according to an exemplary embodiment of the present general inventive concept may be realized by a sensing apparatus including a display to display a photographed screen and a control unit to determine a location where an event is sensed by setting a boundary on the screen. The sensing apparatus may determine a direction in which the event is sensed by setting directionality of the boundary and cause a separate event to occur based on the location and direction in which the event is sensed.

The sensing apparatus may further include a user input unit to set directionality, and if a drag is input via the user input unit, the control unit may set the directionality based on the drag.

The control unit may set the directionality from a location where the drag starts to a location where the drag ends or the drop is input.

The boundary may be composed of at least one line.

If a user sets directionality in a direction which crosses the at least one line, the control unit may set the directionality according to the user's manipulation.

The control unit may cause an independent separate event to occur according to at least one of a location and a direction in which the event is sensed.

The sensed event may be an event in which an object appears on the photographed screen.

The separate event may include at least one of storing a screen displayed on the display, transmitting a control signal regarding the photographed object, and transmitting a control signal regarding an object around the photographed object.

Features and/or utilities of the present general inventive concept may also be realized by a sensing apparatus including a display to display a photographed screen and a control unit to determine a location where an event is sensed by setting a boundary on the screen. The sensing apparatus may determine a direction in which the event is sensed by setting directionality of the boundary and may cause a separate event to occur based on the location and direction in which the event is sensed.

Features and/or utilities of the present general inventive concept may also be realized by an event sensing method including displaying a photographed screen, setting a boundary to determine a location where an event is sensed on the screen, setting directionality of the boundary to determine a direction where the event is sensed, and causing a separate event to occur based on at least one of a location and a direction where the event is sensed.

The setting directionality, if a dragging is input by the user input unit, may set the directionality based on the dragging.

The setting directionality may set the directionality from a location where the drag starts to a location where the drag ends or the drop is input.

The boundary may be composed of at least one line.

The setting directionality, if a user's manipulation is input in a direction which crosses the at least one line, may set the directionality according to the input direction.

The causing a separate event to occur may cause an independent separate event to occur according to a location and a direction where the event is sensed.

The sensed event may be an event in which an object appears on the photographed screen.

The separate event may include at least one of an event in which a screen displayed on the display is stored, a control signal regarding the photographed object is transmitted, and a control signal regarding the object around the photographed object is transmitted.

An event sensing method, according to an exemplary embodiment of the present general inventive concept, includes displaying a photographed screen, setting a boundary of the screen to determine a location where an event is sensed on the screen, setting directionality of the boundary to determine a direction where the event is sensed, and generating a control command based on at least one of the location and the direction where the event is sensed.

Features and/or utilities of the present general inventive concept may also be realized by a photographing system including a photographing apparatus, a display apparatus to display the photographed screen of the photographing apparatus, a user input apparatus to set a boundary of the screen and directionality of the boundary, and a control apparatus to determine a location where an event in sensed on the screen based on the set boundary, to determine a direction where the event is sensed based on the set directionality, and to cause a separate event to occur based on at least one of the location and the direction where the event is sensed.

Features and/or utilities of the present general inventive concept may also be realized by a method of triggering an event, the method including displaying a plurality of images on a screen, forming a first boundary on the screen corresponding to a location in the plurality of images, and triggering an event when a first object in the plurality of images crosses the first boundary.

The event may be triggered only when the first object crosses the first boundary in a predetermined direction.

The predetermined direction may be determined by sensing a direction of movement of a cursor on the screen across the first boundary so that the predetermined direction corresponds to the direction of movement of the cursor.

The first boundary may be a line segment or a polygon.

The predetermined direction may be determined by sensing a direction of movement of a cursor on the screen across the first boundary so that the predetermined direction corresponds to the direction of movement of the cursor, the predetermined direction may correspond to any direction leading into the polygonal shape when the cursor is moved into the polygonal shape, such that the event is triggered when the first object moves into the polygonal shape, and the predetermined direction may correspond to any direction leading out of the polygonal shape when the cursor is moved out of the polygonal shape, such that the event is triggered when the first object moves out of the polygonal shape.

The event may include transmitting a signal to control the first object.

The event may include transmitting a signal to control a second object.

The second object may be located within the plurality of images.

The event may include controlling an image capture device.

The controlled image capture device may also capture the plurality of images displayed on the screen.

Controlling the image capture device may include causing an image-capturing end of the image capture device to change location, such that a background of subsequent captured images differs from a background of previous captured images.

The first boundary corresponds to a location within the plurality of images that is separated by a predetermined distance from an edge of the plurality of images.

Triggering an event when a first object in the plurality of images crosses the first boundary may include forming a second boundary around the first object and triggering the event when the second boundary contacts the first boundary.

Forming the second boundary may include identifying an outer edge of the first object in the plurality of images and forming the second boundary to correspond to the outer edge of the first object.

Identifying the outer edge of the object in the plurality of images may include, when the first object changes position from a first image of the plurality of images to a second image of the plurality of images, adjusting at least one of a shape and a location of the second boundary to correspond to the changed position of the object.

Triggering an event when a first object in the plurality of images crosses the first boundary may include triggering the event only when it is determined that the first object has at least one of a predetermined shape, mass, height, profile, or speed.

Features and/or utilities of the present general inventive concept may also be realized by an apparatus to trigger an event, including a computing device to receive a plurality of images, to generate a first boundary corresponding to a location in the plurality of images, and to trigger an event when a first object in the plurality of images crosses the first boundary, a display to display the plurality of images and the boundary, and an input device to receive an input to generate the boundary.

The computing device may receive a directional cue from the input device and triggers the event only when the first object crosses the first boundary in a direction indicated by the directional cue.

The computing device may trigger the event only when the first object crosses the first boundary from an outside of the polygon to an inside of the polygon.

The computing device may trigger the event only when the first object crosses the first boundary from an inside of the polygon to an outside of the polygon.

The computing device may trigger the event by transmitting a signal to control the first object.

The computing device may trigger the event by transmitting a signal to control a second object.

The computing device may trigger the event by transmitting a signal to control an image-capture device.

The computing device may generate a second boundary around the first object and trigger the event when the second boundary contacts the first boundary.

Features and/or utilities of the present general inventive concept may also be realized by a monitoring system to trigger an event, including an image-capture device to capture a plurality of images, a computing device to receive the plurality of images, to generate a first boundary corresponding to a location in the plurality of images, and to trigger an event when a first object in the plurality of images crosses the first boundary, a display to display the plurality of images and the boundary, and an input device to receive an input to generate the boundary.

Features and/or utilities of the present general inventive concept may also be realized by a monitoring apparatus to trigger an event including a computing device to display an image, to generate a boundary corresponding to a location in the image, to update the image to correspond to movement of an object in the image, and to trigger an event when the object crosses the boundary.

The monitoring apparatus may include an input device to receive an input from a user and to cause the computing device to generate the boundary having dimensions determined by the user.

The computing device may trigger the event only when the object crosses the boundary in a predetermined direction defined by the user.

Features and/or utilities of the present general inventive concept may also be realized by a computer-readable medium having stored a code to execute a method, the method including displaying a plurality of images on a screen, forming a first boundary on the screen corresponding to a location in the plurality of images, and triggering an event when a first object in the plurality of images crosses the first boundary.

Features and/or utilities of the present general inventive concept may also be realized by a computer-readable medium having code stored thereon to execute a method, the method including displaying a plurality of images on a screen, forming a first boundary on the screen corresponding to a location in the plurality of images, and triggering an event when a first object in the plurality of images crosses the first boundary.

### BRIEF DESCRIPTION OF THE DRAWINGS

The above and/or other aspects of the present general inventive concept will be more apparent by describing certain exemplary embodiments of the present general inventive concept with reference to the accompanying drawings, in which:

FIG. 1 is a view provided to explain a photographing system 100 according to an exemplary embodiment of the present general inventive concept;

FIG. 2A and FIG. 2B illustrate setting a boundary and directionality on a screen;

FIG. 3A and FIG. 3B illustrate setting a boundary and directionality on a photographed screen;

FIG. 4A and FIG. 4B illustrate sensing an object;

FIG. 5A and FIG. 5B illustrate sensing an event according to an exemplary embodiment of the present general inventive concept;

FIG. 6 is a block diagram of the above-mentioned controlling apparatus;

FIGS. 7A-7C illustrate an a virtual image and boundary according to another embodiment of the present general inventive concept; and

FIGS. 8A and 8B illustrate methods of selecting a directional trigger according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description, such as detailed construction and elements, are provided to assist in a comprehensive understanding of the general inventive concept. Thus, it is apparent that the present general inventive concept can be carried out without those specifically defined matters. Also, well-known functions or constructions are not described in detail since they would obscure the general inventive concept with unnecessary detail.

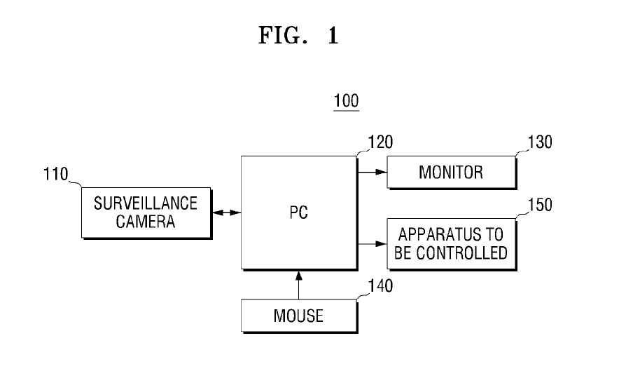

FIG. 1 is a view provided to explain a photographing system 100 according to an exemplary embodiment of the present general inventive concept. Although described as a photographing system, the system may involve still photographs, video, virtual representations of locations, or any other image-capture system. As illustrated in FIG. 1, the photographing system 100 comprises a surveillance camera 110, a personal computer (PC) 120, a monitor 130, a mouse 140, and an apparatus to be controlled 150. The surveillance camera 110 may be a time-lapse camera, a still camera, a video camera, or any other image-capture device. The personal computer 120 may be any computing device capable of receiving, processing, and transmitting signals, as described below, and is not limited to the personal computer illustrated in FIG. 1 to provide an example embodiment. The monitor 130 may be any display device including a personal display device, a stand-alone display device, a display incorporated in a stationary or mobile device, a television monitor, or a computer monitor. The mouse 140 may be any input device and is not limited to the mouse 140 illustrated in FIG. 1 to provide an example embodiment.

The surveillance camera 110 is a photographing apparatus and generates an image signal of a photographed image after a subject is photographed. The photographed image may be a still image or a moving image. The surveillance camera 110 transmits the image signal of the photographed image to the PC 120 which will be explained later, receives a control command from the PC 120, and operates according to the received control command. For instance, if a control command to change a photographing angle is received from the PC 120, the surveillance camera 110 changes the photographing angle following the control command and photographs a subject at a changed angle.

In an exemplary embodiment of the present general inventive concept, a single surveillance camera 110 is connected to the PC 120, but this is only an example. The technical feature of the present general inventive concept may also be applied when two or more surveillance cameras 110 are connected to the PC 120.

The PC 120 may be a type of control apparatus and may receive a photographed image from the surveillance camera 110. If the surveillance camera 110 receives a compressed photographed image, the PC 120 performs signal processing on the image input from the surveillance camera 110, such as decompressing the compressed image, converts the format of the image so as to display the image on the monitor 130 and transmits the image to the monitor 130.

The PC 120 not only performs signal processing on an image, but may also add a graphic user interface (GUI) to the image so that a GUI may be generated on a screen according to manipulation by a user. The PC 120 may be a specialized device to perform substantially only the monitoring and control functions of the present general inventive concept, or it may perform additional functions unrelated to the present general inventive concept.

In addition, the PC 120 sets a boundary on a screen to define a location on a screen that will be monitored to determine if a predetermined event occurs. The PC 120 also sets directionality of the boundary, or a directional trigger, to define a specific direction or a predetermined direction. When an event is sensed on the boundary in the specific direction, the PC 120 causes a separate event to occur based on the location or the direction where the event is sensed.

The separate event may be any function initiated by the PC 120 as a result of the event being sensed on the boundary in the specific direction. For example, as discussed in further detail below, if an object crosses the boundary in the specific direction, the PC 120 may send a signal to control the object or another object, including the PC 120, an image-capture device, or an object to interact with the sensed object.

The sensed event may include an event in which an object appears on a photographed screen. In other words, a camera may take a photograph or video image, the image may be displayed on the screen, and the event may involve an object in the image that appears on the screen. The separate event may include an event in which a screen is stored, a control signal regarding the object that appears on the screen is transmitted, or a control signal regarding the object around the object that appears on the screen is transmitted.

For instance, as an example of an object that appears on a screen being controlled, a signal lamp that appears on the screen may be controlled. As an example of an object around the object that appears on the screen being controlled, a street lamp which is near the signal lamp but is not displayed on the screen may be controlled.

The monitor 130 may be a type of display apparatus, and may receive an image which is photographed or captured by the surveillance camera 110 and signal-processed by the PC 120. The monitor may display the image on a screen. In addition, the monitor 130 may display a GUI on the screen. The GUI may be generated by the PC 120.

The mouse 140 is an input apparatus that controls the PC 120 or is used to control the surveillance camera 110, the monitor 130, or the apparatus to be controlled 150 via the PC 120. The apparatus to be controlled 150 will be explained later. Particularly, the mouse 140 receives a user's manipulation to set a boundary on a screen where a photographed image is displayed and to set directionality of the boundary, and generates a signal according to the user's manipulation and transmits the signal to the PC 120.

The boundary represents a line to determine a location of a sensed event on a screen where a photographed image is displayed. For instance, if a user manipulates the mouse 140 and generates a certain line on the screen where a photographed image is displayed, the line is used to sense an event in which an object approaches the line or penetrates the line.

The line generated by the manipulation of the mouse 140 by a user is generated on the screen as a GUI, and a user may set one or a plurality of locations of a sensed event by generating one or more lines. Since a polygon may be regarded as combination of a plurality of lines, the technical feature of the present general inventive concept may be applied to the case when not only a line is used, but also a polygon is used.

The directionality represents a direction the PC 120 senses when an object moves. That is, if a line is generated up and down and directionality of right and left is set to the line generated up and down, the PC 120 may generate a separate event by sensing only an object which moves right and left.

A detailed method of setting directionality will be explained below.

The apparatus to be controlled 150 represents any object which may be connected to the PC 120 and controlled by the PC 120. Accordingly, the apparatus to be controlled 150 may be an object that appears on a screen, or an object that is not displayed on the screen.

As such, a boundary and directionality of the boundary are set using the photographing system 100, and thus a location and direction where an event is sensed is determined. Accordingly, a separate event may occur according to the sensed location and direction.

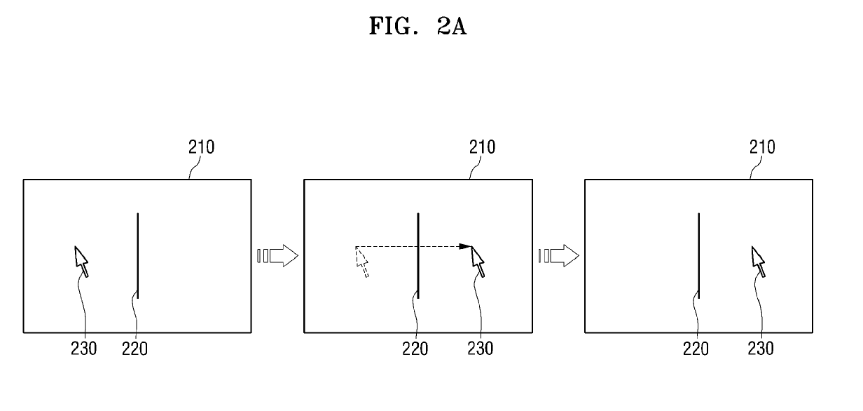

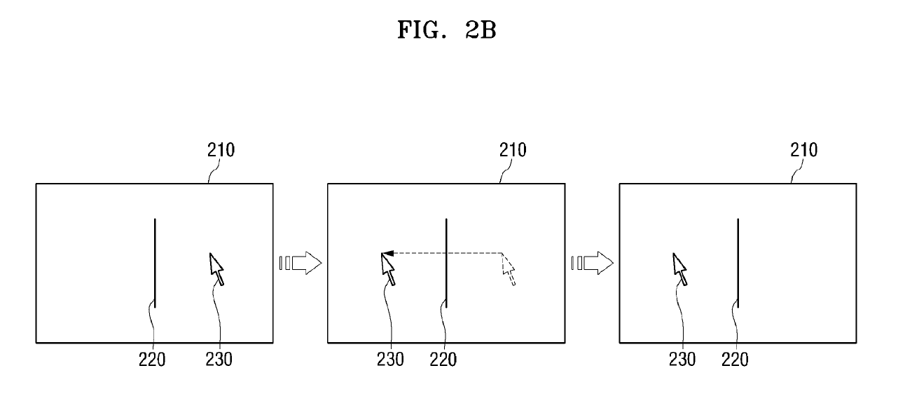

FIG. 2A and FIG. 2B are views provided to explain how to set a boundary and direction on a screen.

As illustrated in FIG. 2A, if a user sets a boundary 220 on a screen 210 and drags a cursor 230 left to right using the mouse 140, the boundary 220 is set from left to right. Specifically, if the drag which begins on the left of the boundary 220 ends on the right of the boundary 220, directionality of left to right is set to the boundary 220. Accordingly, an object which moves from a left side of the boundary to a right side of the boundary 220 is sensed and displayed on a screen, and when the object is sensed, a separate event may be set to occur.

Generally, a mouse drag includes pressing a button, moving the mouse, and releasing the button. However, any method of making a selection and moving in a direction may be used. For example, a double key press may be used and a mouse may be moved, or a first key may be pressed to begin the direction selection and other keys (such as arrow keys) may be pressed to select the direction. In other words, any method of selecting or illustrating directional movement may be used to select a directional trigger of the boundary 220, and the term “drag” or “dragging” in the specification and claims refers to such a method of selecting a directional movement.

As illustrated in FIG. 2B, if a user sets a boundary 220 on a screen 210 and drags a cursor 230 right to left using the mouse 140, the boundary 220 is set from right to left. If the drag which begins on the right of the boundary 220 ends on the left of the boundary 220, directionality of right to left is set to the boundary 220. Accordingly, an object which moves from a right side of the boundary to a left side of the boundary 220 on the screen is sensed, and a separate event may be set to occur.

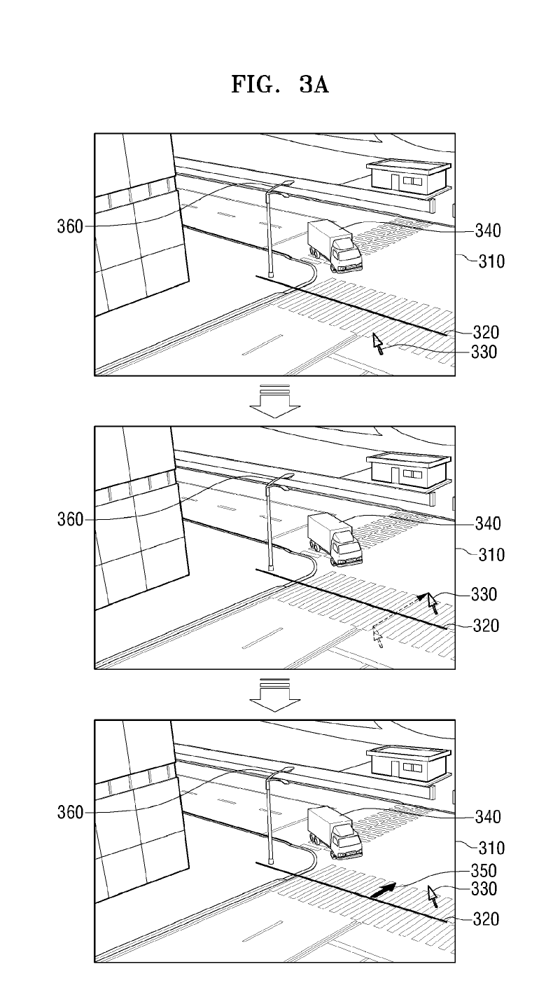

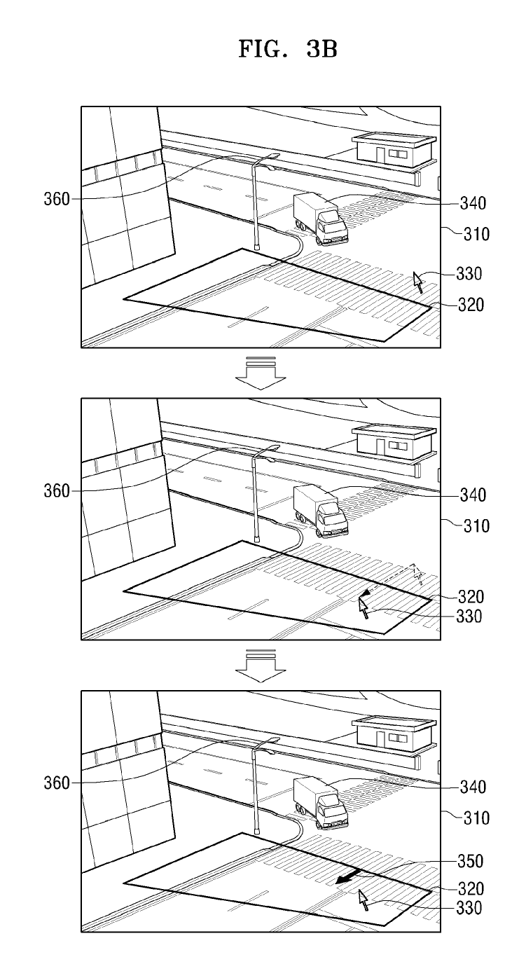

FIG. 3A and FIG. 3B are views provided to explain how to set a boundary and directionality on a photographed screen.

Just like FIG. 2A and FIG. 2B, FIG. 3A and FIG. 3B provide explanation on how to set a boundary and directionality, but FIG. 3A and FIG. 3B explain how to set a boundary and directionality not just on a random screen but on a screen 310 photographed by the surveillance camera 110.

As illustrated in FIG. 3A, if the boundary 320 is set from upper left to lower right, and a user drags the cursor 330 from lower left to upper right, directionality 350 of lower left to upper right is set to the boundary 320.

Accordingly, even if an object 340 on the photographed screen 310 moves from upper right to lower left of the boundary 320, a separate event does not occur since the direction of the object 340 is opposite to the set directionality 350.

As illustrated in FIG. 3B, if the boundary 320 with a polygon of 4 lines is set, and a user drags the cursor 330 from upper right (outside) to lower left (inside), the directionality 350 of upper right to lower left is set to the boundary 320.

Accordingly, if an object 340 on the photographed screen 310 moves from upper right to lower left of the boundary 320, a separate event occurs since the direction of the object 340 is the same as the set directionality 350.

As described above, a separate event may be an event regarding controlling the photographed object 340 such as transmitting a command to lower the speed of the object 340 to the object 340, or an event regarding controlling an object around the photographed object 340 such as transmitting a command to turn on a street lamp 360 which is displayed on the screen or to turn on a street lamp which is not displayed on the screen.

In the above description, only one direction is set to a boundary with one line, but this is only an example. The present general inventive concept may also be applied when bi-directionality is set to a boundary with one line. In this case, if an object is sensed moving in either direction across the boundary, a separate event may be generated.

For example, a computing device such as the PC 120 may generate a screen on the monitor 130 that includes a captured image and a graphic user interface. The user may select a symbol on the graphic user interface to enter a boundary-selection mode. The user may then form a pre-defined boundary on the screen or may form a boundary having a customized shape. The user may indicate any of the size, shape, and location of the boundary by manipulating an input device, such as the mouse 140, to adjust a location of a cursor on the screen.

Once the user defines the characteristics of the boundary, the user may then select another symbol of the graphic user interface to select a direction trigger of the boundary. The user may select one or more directions to trigger the event while the direction trigger mode is selected. For example, if the user selects the direction trigger mode by selecting the corresponding symbol of the graphic user interface, the user may drag the cursor across a boundary to set a first direction trigger in the direction of the cursor-drag. The user may then drag the cursor in another direction across the boundary to set another direction trigger, so that the computing device triggers the event if an object crosses the boundary travelling in either the first direction or the second direction.

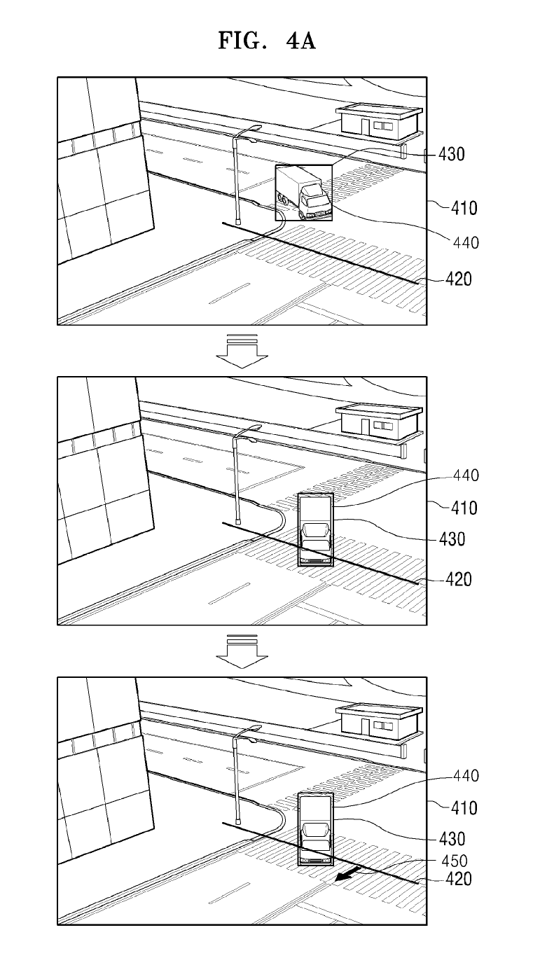

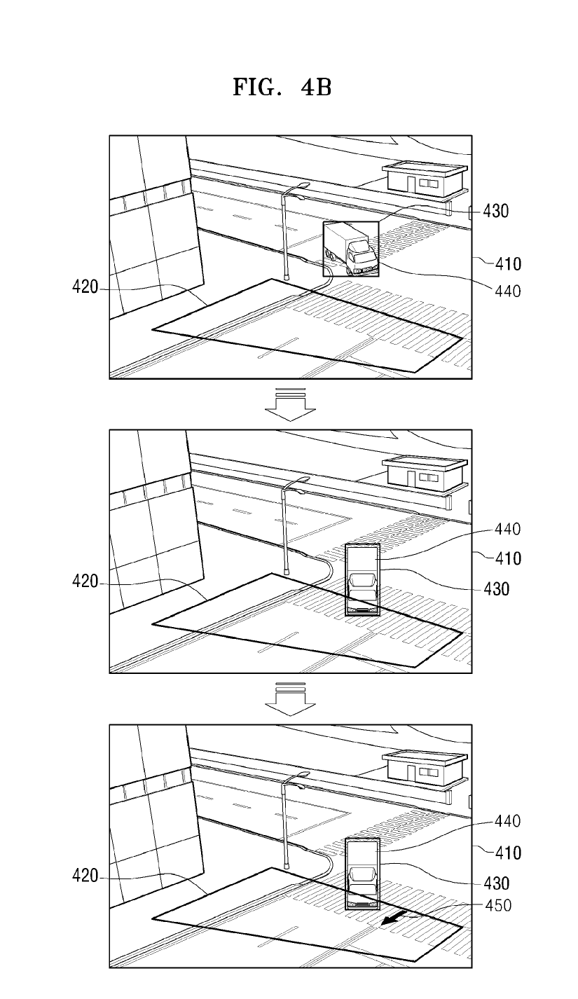

Alternatively, the user may select one or more boundaries and the computing device may generate a graphic user interface to allow the user to select a direction trigger for the selected boundaries. For example, if the user selects a first boundary, a menu may appear on the screen to allow the user to select one or more directions associated with the first boundary to be direction triggers. If the boundary is a polygon having multiple lines, the graphic user interface may allow the user to select a direction “into” the polygon or “out of” the polygon, so that the direction trigger includes a plurality of directions. FIG. 4B, below, illustrates a boundary having multiple lines.

FIG. 4A and FIG. 4B are views provided to explain how an object 440 may be sensed crossing a boundary 420. As illustrated in FIG. 4A, if an object 440 appears on a photographed screen 410, the PC 120 determines whether the object 440 has mobility, and if it is determined that the object 440 has mobility, the PC 120 sets a boundary 430 of the object 440. The boundary 430 of the object 440 is different from the boundary 420 which is set by a user to sense an event. The boundary 430 of the object 440 may correspond to an outer edge or a profile of the object, but may also be a center point or center of mass of the object, or any other “boundary” 430 to trigger an event.

Whenever the object moves, the PC 120 renews the boundary 430 of the object 440 based on the size, location, and velocity of the moved object 440, and displays the renewed information on a screen 410. For example, if the outer edge of the object 440 is used as the object boundary 430 and the object 440 moves and its profile changes with respect to the image-capture device, the PC 120 analyzes the changed shape of the outer edge of the object 440 and adjusts the shape of the object boundary 430 accordingly.

As illustrated in the second view of FIG. 4A, if the boundary 430 of the object 440 contacts the boundary 420 set by a user, the PC 120 determines directionality of the boundary 430 of the object 440 and directionality 450 of the boundary preset by a user. If the directionalities of the two boundaries are the same, the PC 120 generates a control signal to cause an event to occur, and if the directionalities of the two boundaries are not the same, the PC 120 does not generate a control signal to cause an event to occur.

FIG. 4B is a view in which the boundary 420 set by a user is a polygon. Since the detailed operation of FIG. 4B is the same as that of FIG. 4A, the description will be omitted.

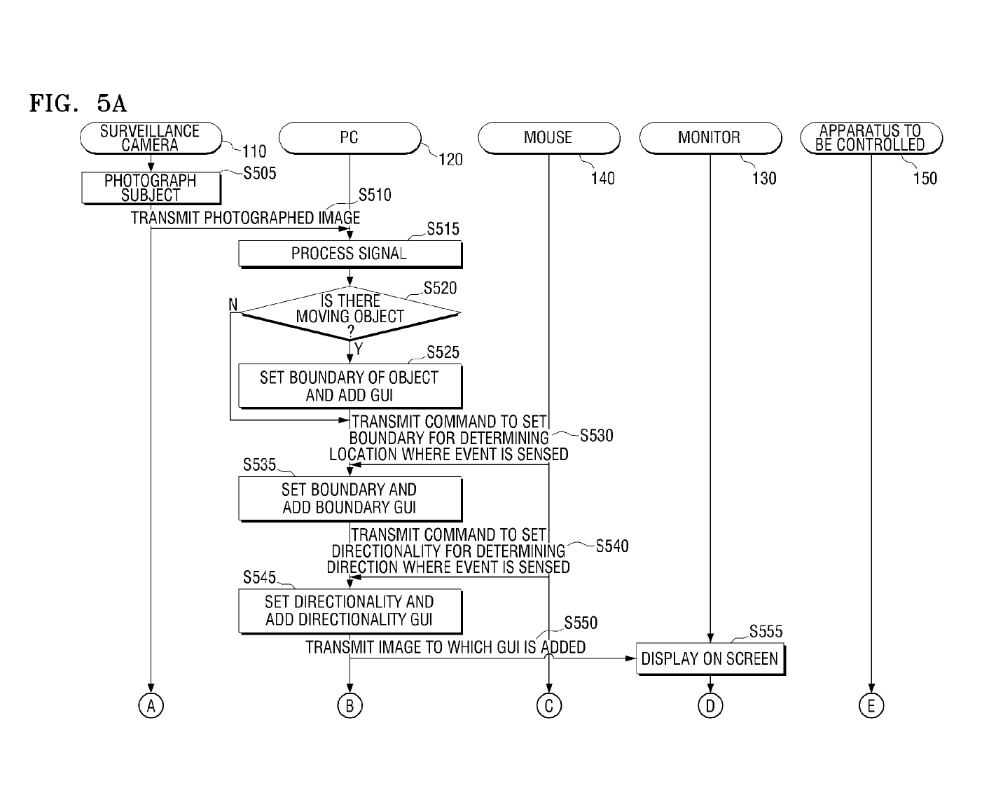

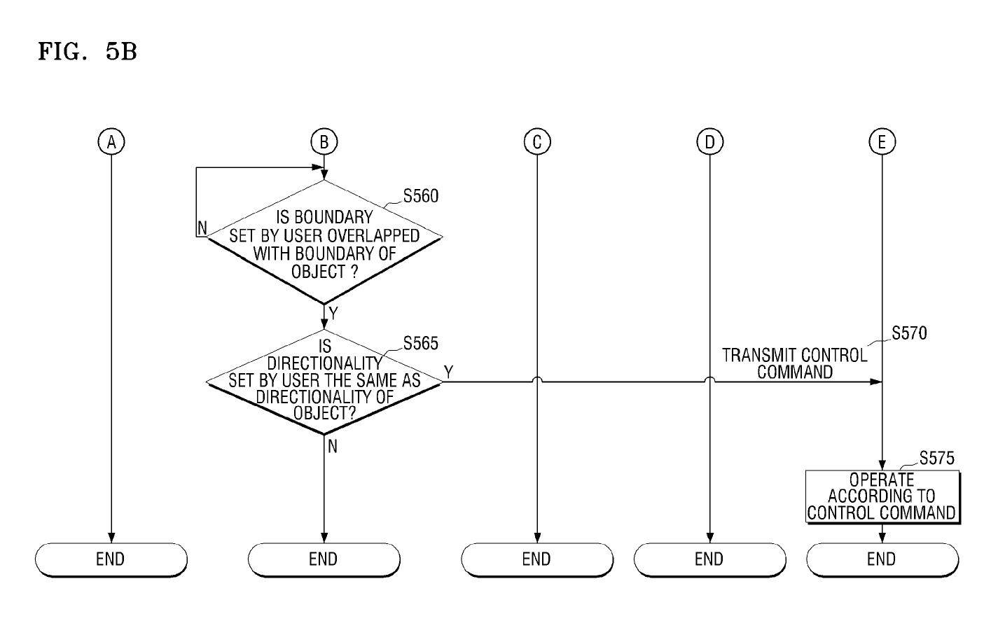

FIG. 5A and FIG. 5B are views provided to explain how to sense an event according to an exemplary embodiment of the present general inventive concept.

The surveillance camera 110 photographs a subject (S505), and transmits the photographed image to the PC 120 (S510).

The PC 120 performs signal processing on the image received from the surveillance camera 110 (S515), and determines whether there is an object that moves from the signal-processed image (S520). If it is determined that there is a moving object, the PC 120 sets a boundary for the moving object and adds a GUI corresponding to the boundary to the image (S525).

If a command to set a boundary for determining a location where an event is sensed is received from the mouse 140 (S530), the PC 120 sets the boundary according to the command received from the mouse 140, and adds a GUI corresponding to the set boundary to an image (S535).

If a command to set a direction where an event is sensed is received from the mouse 140 (S530), the PC 120 sets the direction of the boundary according to the command received from the mouse 140, and adds a GUI corresponding to the set direction to the image (S545).

The PC 120 transmits the image to which a boundary GUI of an object, a boundary GUI set by a user, and a directionality GUI set by a user are added, to the monitor 130 (S550), and the monitor displays the image with the GUIs on a screen (S555).

The PC 120 repeats the operation of receiving an image from the surveillance camera 110, performing signal processing, and adding a GUI to the image, and determines whether a boundary set by a user is overlapped with a boundary of an object during the above operation (S560). If it is determined that the boundary set by a user is overlapped with the boundary of an object (S560-Y), the PC 120 determines whether the directionality set by the user is the same as the directionality of the object (S565). If it is determined that the two directionalities are the same (S565-Y), the PC 120 transmits a control command to the apparatus to be controlled 150 (S570).

The apparatus to be controlled 150 performs operation according to the received control command (S575).

Accordingly, a direction where an event is sensed can be set more easily and conveniently on a photographed screen.

In the above description, the surveillance camera 110, the PC 120, the monitor 130, and the mouse 140 have been taken as examples of a photographing apparatus, a controlling apparatus, a display apparatus, and an input apparatus respectively, but these are only examples. The technical feature of the present general inventive concept may be applied when separate apparatuses are used as a photographing apparatus, a controlling apparatus, a display apparatus, and an input apparatus.

For instance, a display apparatus may operate as a touch screen. In this case, a user may set direction of an event sensed on a photographed screen more easily and conveniently by simply touching the screen or dragging without a separate user input apparatus. Other input apparatuses may be used, such as a track ball, a sense pad, or any other device useable by a user to move a pointer generated on a screen.

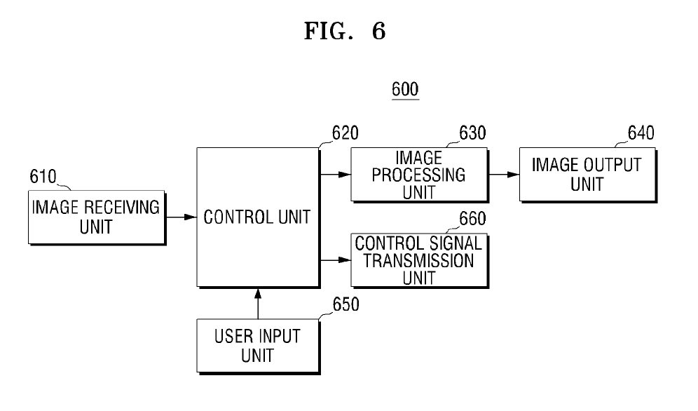

FIG. 6 is a block diagram of the above-mentioned controlling apparatus. The controlling apparatus may be the above-mentioned PC 120 or a separate controlling apparatus.

As illustrated in FIG. 6, a controlling apparatus 600 comprises an image receiving unit 610, a control unit 620, an image processing unit 630, an image output unit 640, a user input unit 650, and a control signal transmission unit 660.

The image receiving unit 610 receives a photographed image from an external photographing apparatus and transmits it to the control unit 620. The image-receiving unit 610 may include a light-receiving unit, a radio-wave-receiving unit, a wireless signal-receiving unit, or any other unit that may receive data from a physical location. The image-receiving unit 610 may include a processor, logic, and memory to convert the received image to a signal that may be transmitted to the control unit 620.

The control unit 620 controls overall operation of sensing an event based on the image received from the image receiving unit 610 and the user input unit 650 which will be explained later. In particular, the control unit 620 controls the control signal transmission unit 660 so as to perform signal processing on the received image and add a GUI to the received image according to a user's GUI manipulation. The control unit 620 also controls the control signal transmission unit 660 so that if an event is sensed and directionality is the same, a separate event may be generated.

Specifically, the control unit 620 analyzes a boundary of an object, a boundary set by a user, and directionality set by a user, and determines a location where an event is sensed based on whether the boundary of the object is the same as the boundary set by a user. The control unit 620 determines a direction in which the event is sensed based on whether the boundary of the object is the same as the boundary set by a user, and causes a separate event to occur based on the location and direction in which the event is sensed.

The control unit 620 may include one or more processors, logic units, and memory to receive data from various inputs, to process and store the data, and to output data and commands to the image-processing unit 630 and the control signal transmission unit 660.

The image processing unit 630 performs signal processing on a received image and adds a GUI to the received image according to the image and control command received from the control unit 620. As described above, the GUI includes a boundary GUI of an object, a boundary GUI set by a user, and a directionality GUI set by a user. The image processing unit 630 may include one or more processors, logic units, and memory to receive the image, add a graphic user interface to the image, and output the image in a form that may be displayed by the image output unit 640.

The image which has been signal-processed by the image processing unit 630 and to which a GUI has been added is transmitted to the image output unit 640 and is displayed in the image output unit 640. The image output unit 640 may include any type of display including analog and digital displays, stationary and mobile displays, monitors, TV's, or any other type of display.

The user input unit 650 transmits information regarding a boundary and direction received from a user to the control unit 620. The user input 650 may include one or more processors, logic, and memory, and one or more input devices to receive a user command and to process the user command into electronic signals to control the control unit 620. The input device may be a mouse, track pad, touch pad, wheel, a non-physical-contact input device, or any other input device to allow a user to control the control unit 620.

The control signal transmission unit 660 receives a control signal from the control unit 620 and transmits it to a photographed object or an object around the photographed object. Therefore, a separate event regarding a photographing apparatus, a photographed object and an object around the photographed object may occur. The control signal transmission unit 660 may include one or more processors, logic units, and memory and one or more transceivers or input/output ports to transmit signals to devices outside the controlling apparatus 600. The control signal transmission unit receives commands from the control unit 620, converts the commands to a form usable by an object-to-be-controlled, and transmits the commands to the object-to-be-controlled.

Alternatively, if the object-to-be-controlled is the image receiving unit 610, the control unit 620 may send a command directly to the image receiving unit 610.

The controlling apparatus 600 may be one device within one case, for example, or may include a plurality of interconnected devices. The plurality of devices may be connected via wires or wirelessly to transmit data and commands.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

For example, any one of the image receiving unit 610, control unit 620, image processing unit 630, and control signal transmission unit 660, or any other hardware, may be programmed with code to perform the above functions, including capturing images, processing images, generating boundaries, directional triggers, and graphic user interfaces, and transmitting commands to objects outside the controlling apparatus 600.

Accordingly, direction in which an event is sensed may be set more easily and conveniently on a photographed screen.

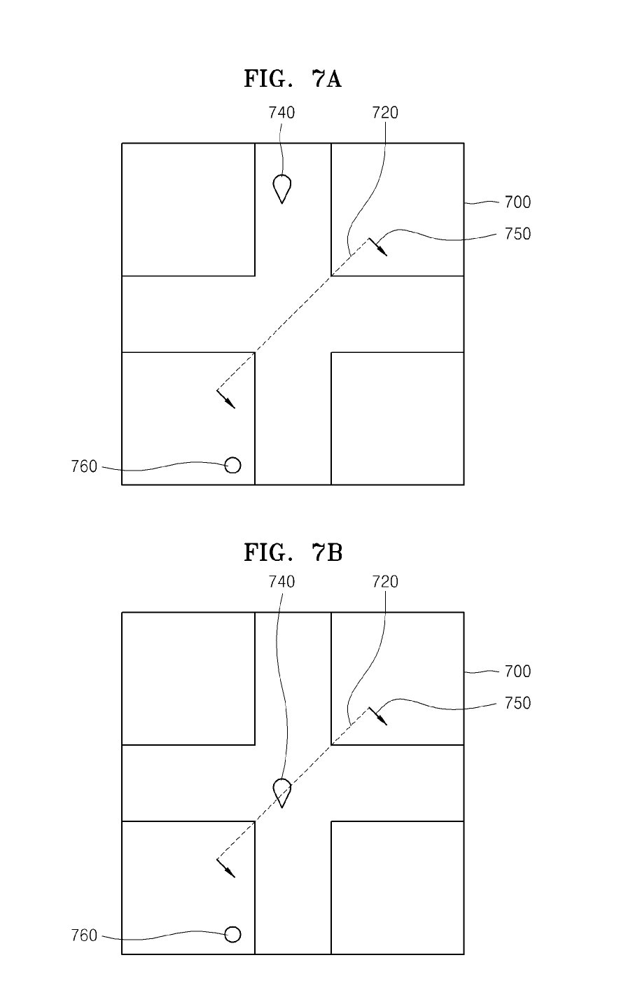

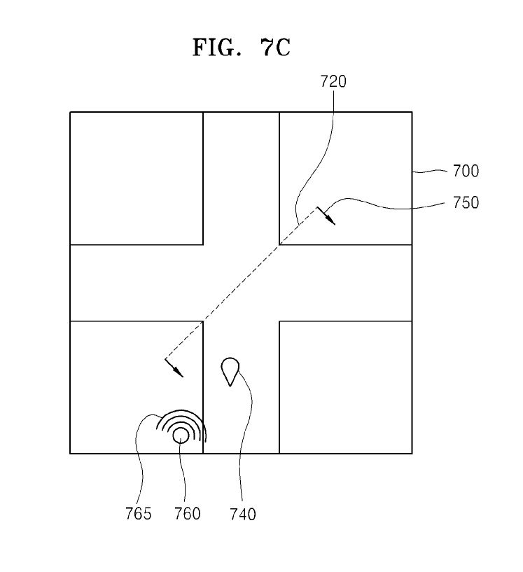

FIGS. 7A-7C illustrate an embodiment of the present inventive concept in which the image captured is a virtual image of an actual location at a present time, or a time sufficiently recent that a controlling apparatus can interact with an object in the image. In FIG. 7A, a screen 700 displays a virtual depiction of a map. The data that forms the basis of the map may be generated from one or more sensors, from pre-existing software, from the Internet, or from any other source. The virtual map may represent an actual location. A boundary 720 may be formed on the map by the process described above. According to one embodiment, a direction indicator or symbol 750 may be added to the display to indicate the directional trigger of the boundary.

A sensor (not shown) may sense a location of an object 740. A computing device (not shown) may determine a direction of the object 740 and may adjust a visual display of the object 740 to indication directional movement. For example, in FIG. 7A, the symbol representing the object 740 includes an arrow pointing towards the bottom of the screen 700, indicating that the object 740 is travelling toward the bottom of the screen 700.

The sensor (not shown) may be a GPS receiver or any other wired or wireless signal transmitter capable of transmitting at least a location of the object 740.

The computing device (not shown) may determine whether the object 740 interacts with the boundary 720 in a direction indicated by the directional trigger 750. The computing device may also determine whether the direction of the object 740 falls within an acceptable range of directions to trigger an event. For example, in FIG. 7B, the symbol 750 indicating the directional trigger is directed to a bottom right corner of the screen 700. The computing device may determine whether the downward travel of the object 740 falls within predetermined bounds. For example, a user may indicate that any object travelling across the boundary either down or to the right triggers the event. Alternatively, a user may indicate that only an object travelling in the exact direction down and to the right triggers the event.

As illustrated in FIG. 7C, the screen 700 may include a representation of a second object 760. If it is determined that the interaction of the object 740 with the boundary 720 triggers an event, the computing device may control the second object 760 to perform a function, such as taking picture, illuminating, communicating with the object 740, or any other function. The computing device may adjust a graphic user interface on the screen 700 to include an indicator 765 that the second object 760 is being controlled.

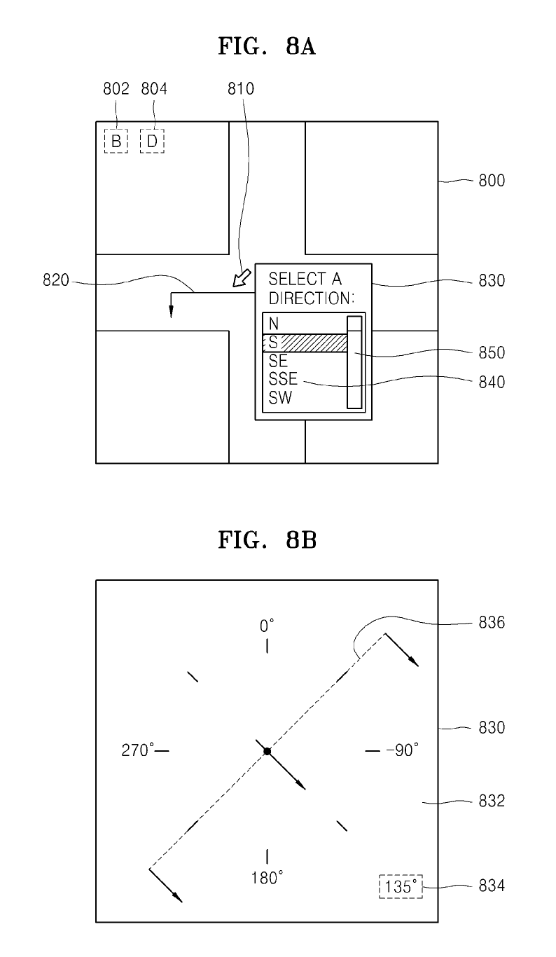

FIGS. 8A and 8B illustrate a graphic user interface to select a direction trigger of an event. FIG. 8A illustrates a screen 800 displaying an image representing an actual location. A user may generate a boundary 820 by selecting the symbol 802 with the cursor 810 and forming the boundary 820 to have a desired length and shape. Next, the user may select the icon 804 representing a direction trigger. A direction selection menu 830 may be generated including a plurality of directions 840, a scroll bar 850 and any other data to allow a user to select a direction trigger of the boundary 820.

FIG. 8B illustrates a direction selection menu 830 including a graphic representation 832 of various angles that may be selected by a user. For example, the user may select and drag the boundary representation 836 to select a direction trigger, or the user may enter an angle 834 to select the direction trigger. Alternatively, any appropriate method may be used to select a boundary size, shape, and direction trigger.

In addition to the direction of the sensed object, as described in the embodiments above, a computing device may further limit an event trigger based on other characteristics of the object. For example, the computing device may trigger the event only if the sensed object has a predetermined size, shape, mass, speed, profile, or any other characteristic that may be determined by the computing device.

The foregoing exemplary embodiments and advantages are merely exemplary and are not to be construed as limiting the present general inventive concept. The present teaching can be readily applied to other types of apparatuses. Also, the description of the exemplary embodiments of the present general inventive concept is intended to be illustrative, and not to limit the scope of the claims, and many alternatives, modifications, and variations will be apparent to those skilled in the art.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A sensing apparatus, comprising:
a display to display a captured image on a screen; and
a control unit to determine a location where an event is sensed by setting a boundary on the screen, to determine a direction in which the event is sensed by setting directionality of the boundary, and to cause a separate event to occur based on the location and direction in which the event is sensed.

2. The sensing apparatus as claimed in claim 1, further comprising:
a user input unit to set directionality,
wherein when a drag is input via the user input unit, the control unit sets the directionality based on the drag.

3. The sensing apparatus as claimed in claim 2, wherein the control unit sets the directionality from a location where the drag starts to a location where the drag ends.

4. The sensing apparatus as claimed in claim 1, wherein the boundary comprises at least one line.

5. The sensing apparatus as claimed in claim 4, wherein if a user sets directionality in a direction to cross the at least one line, the control unit sets the directionality according to the user's manipulation.

6. The sensing apparatus as claimed in claim 1, wherein the control unit causes an independent separate event to occur according to at least one of a location and a direction in which the event is sensed.

7. The sensing apparatus as claimed in claim 1, wherein the sensed event is an event to control an object that appears on the captured image on the screen.

8. The sensing apparatus as claimed in claim 1, wherein the separate event includes at least one of storing a screen displayed on the display, transmitting a control signal regarding a first object in the captured image, and transmitting a control signal regarding a second object in the vicinity of the first object.

9. An event sensing method, comprising:
displaying a captured image on a screen;
setting a boundary to determine a location where an event is sensed on the screen;
setting directionality of the boundary to determine a direction in which the event is sensed; and
causing a separate event to occur based on at least one of a sensed location and a direction of the event.

10. The event sensing method as claimed in claim 9, wherein, if a dragging is input by the user input unit, the directionality is set based on the dragging.

11. The event sensing method as claimed in claim 10, wherein the setting directionality sets the directionality from a location where the drag starts to a location where the drag ends.

12. The event sensing method as claimed in claim 9, wherein the boundary comprises at least one line.

13. The event sensing method as claimed in claim 12, wherein, if a user's manipulation is input in a direction which crosses the at least one line, the directionality is set according to the input direction.

14. The event sensing method as claimed in claim 9, wherein the causing an independent separate event to occur causes a separate event to occur according to a location and a direction where the event is sensed.

15. The event sensing method as claimed in claim 9, wherein the sensed event is an event in which an object appears on the captured image on the screen.

16. The event sensing method as claimed in claim 9, wherein the separate event includes at least one of storing a screen displayed on the display, transmitting a control signal regarding a first object displayed on the screen, and transmitting a control signal regarding a second object near the first object.

17. A photographing system, comprising:
a photographing apparatus;
a display apparatus to display an image captured by the photographing apparatus on a screen;
a user input apparatus to set a boundary on the screen and a directionality of the boundary; and
a control apparatus to determine a location where an event in sensed on the screen based on the set boundary, to determine a direction in which the event is sensed based on the set directionality, and to cause a separate event to occur based on at least one of the sensed location and direction of the event.

18. A method of triggering an event, the method comprising:
displaying a plurality of images on a screen;
forming a first boundary on the screen corresponding to a location in the plurality of images; and
triggering an event when a first object in the plurality of images crosses the first boundary.

19. An apparatus to trigger an event, comprising:
a computing device to receive a plurality of images, to generate a first boundary corresponding to a location in the plurality of images, and to trigger an event when a first object in the plurality of images crosses the first boundary;
a display to display the plurality of images and the boundary; and
an input device to receive an input to generate the boundary.
